(19) United States
(12) Patent Application Publication
(10) Pub. No.: US 2026/0343692 A1
(43) Pub. Date: Oct. 29, 2026

(54) DRAWER-TYPE MICROWAVE OVEN AND CONTROL METHOD

(71) Applicants: Guangdong Galanz Enterprises Co., Ltd., Foshan City (CN); Guangdong Galanz Appliances Manufacturing Co., Ltd., Zhongshan City (CN); Guangdong Galanz Microwave Oven and Electrical Appliances Manufacturing Co., Ltd., Foshan City (CN)

(72) Inventors: Liang Wang FENG, Foshan City (CN); Feng LI, Foshan City (CN); Xiao Qiang CHEN, Foshan City (CN); Ren Sheng DENG, Foshan City (CN); Qin Zheng SU, Foshan City (CN)

(21) Appl. No.: 19/659,702

(22) Filed: Apr. 27, 2026

(30) Foreign Application Priority Data
Apr. 29, 2025 (CN) 202520838229.6
Jan. 5, 2026 (CN) 202610005819.X

(51) Int. Cl. H05B 6/64; A47B 88/457

(52) U.S. Cl. CPC H05B 6/6414; A47B 88/457; H05B 6/6444

(57) ABSTRACT

A drawer-type microwave oven and a control method therefor. The drawer-type microwave oven includes an oven body, a drawer connected to the oven body, a motor that drives the drawer to move in a front-rear direction relative to the oven body, and a lighting assembly including an oven lamp. The control method includes powering on the drawer-type microwave oven and controlling the oven lamp based on the state of the drawer-type microwave oven and the motor operation. The control method for a drawer-type microwave oven enhances convenience of use and improves control flexibility without being limited to a single oven door state control mode, and being capable of flexibly adjusting the on/off state of the oven lamp according to different usage scenarios and operating conditions to better satisfy diversified usage requirements of users and improving user experience of the product.

### CROSS-REFERENCE TO RELATED APPLICATIONS

This application claims priority to Chinese Patent Application No. 202520838229.6 filed with the China National Intellectual Property Administration (CNIPA) on Apr. 29, 2025, and Chinese Patent Application No. 202610005819.X filed with CNIPA on Jan. 5, 2026, the disclosures of both of which are incorporated herein by reference in their entireties.

### FIELD

The present disclosure relates to the technical field of home appliances, and more particularly, to a drawer-type microwave oven and a control method.

### BACKGROUND

In current drawer-type microwave ovens, an oven lamp is installed to illuminate the cavity, facilitating observation by consumers of the cooking state of food within the cavity.

In the prior art, microwave ovens control the oven lamp solely based on the door state: when the oven door is opened, the oven lamp automatically turns on; when the oven door is closed, the oven lamp automatically turns off. Although this control logic is simple, low-cost, and conforms to energy-saving principles, it is limited to a single door state control mode, resulting in poor control flexibility and an inability to satisfactorily meet the diverse usage needs of users.

Meanwhile, in the prior art, the central axis of the oven lamp is disposed perpendicular to the top wall of the cooking chamber, and the cooking chamber is recessed inwardly at the installation location of the oven lamp. On one hand, this occupies space in the cooking chamber, reducing the usable area of the cooking chamber; on the other hand, it reduces the structural strength of the cooking chamber; furthermore, the heat dissipation performance of the oven lamp is poor.

In view of the foregoing, the present disclosure is hereby proposed.

### SUMMARY

The objective of the present disclosure is to provide a drawer-type microwave oven and a control method to address the problems in the prior art of being limited to a single door state control mode, having poor control flexibility, and being unable to satisfactorily meet the diverse usage needs of users; meanwhile, in the prior art, the central axis of the oven lamp is disposed perpendicular to the top wall of the cooking chamber, and the cooking chamber is recessed inwardly at the installation location of the oven lamp, which, on one hand, occupies space in the cooking chamber, reducing the usable area of the cooking chamber; on the other hand, reduces the structural strength of the cooking chamber; and furthermore, results in poor heat dissipation performance of the oven lamp.

To achieve the above objective, the technical solution of the present disclosure is implemented as follows:

A control method for a drawer-type microwave oven, wherein the drawer-type microwave oven comprises an oven body, a drawer, a motor, and a lighting assembly, the drawer is connected to the oven body, the motor is configured to drive the drawer to move in a front-rear direction relative to the oven body, the oven body comprises an inner liner, a heating cavity is formed within the inner liner, a protruding portion is provided on a top wall of the inner liner, a light-transmitting hole is provided on the protruding portion, the lighting assembly is disposed above and outside the protruding portion, the lighting assembly comprising:
an oven lamp, wherein the oven lamp corresponds in position to the light-transmitting hole, and a central axis of the oven lamp is disposed parallel to the top wall;
a flat light-transmitting lamp cover, wherein the flat light-transmitting lamp cover is disposed between the oven lamp and the top wall;
a light-collecting protective lamp cover, wherein the light-collecting protective lamp cover is disposed over the exterior of the oven lamp, the oven lamp is mounted on the light-collecting protective lamp cover, and a heat dissipation hole structure is provided on the light-collecting protective lamp cover;
the control method comprising the following steps:
   S1: powering on the drawer-type microwave oven;
   S2: controlling the oven lamp based on a state of the drawer-type microwave oven and motor operation.

Further, step S2 comprises the following steps:
S21: determining whether the drawer-type microwave oven is in an operating state;
S22: if the drawer-type microwave oven is in the operating state, turning on the oven lamp;
S23: if the drawer-type microwave oven is not in the operating state, determining whether the motor control unit (MCU) has received a motor operation command;
S24: if the MCU has not received a motor operation command, turning off the oven lamp.

Further, step S2 further comprises the following steps:
S25: if the MCU receives a motor operation command, determining whether the motor operation direction is forward rotation for door opening or reverse rotation for door closing;
S26: if the motor is in forward rotation for door opening, entering a motor forward rotation door opening determination mode;
S27: if the motor is in reverse rotation for door closing, entering a motor reverse rotation door closing determination mode.

Further, the motor forward rotation door opening determination mode specifically comprises the following steps:
the motor performs forward rotation for door opening;
the oven lamp is turned on.

Further, the motor reverse rotation door closing determination mode comprises the following steps:
the motor performs reverse rotation for door closing;
determining whether the motor has stopped;
if the motor has not stopped, the oven lamp is turned on.

Further, the motor reverse rotation door closing determination mode further comprises the following steps:
if the motor has stopped, acquiring the motor frame ground (FG) voltage v;
determining whether the motor FG voltage v > a preset stall voltage threshold V3;
if the motor FG voltage v > the preset stall voltage threshold V3, the motor has stopped due to stall, and the oven lamp is turned on;
if the motor FG voltage v ≤ the preset stall voltage threshold V3, the motor has not stopped due to stall, and the oven lamp is turned off.

Further, step S25 specifically comprises the following steps:
S251: if the MCU receives a motor operation command, acquiring the motor FG voltage v;
S252: determining whether the motor FG voltage v > a first preset voltage threshold V1;
S253: if the motor FG voltage v > the first preset voltage threshold V1, then the motor performs forward rotation for door opening;
S254: if the motor FG voltage v ≤ the first preset voltage threshold V1, then determining whether the motor FG voltage v > a second preset voltage threshold V2;
S255: if the motor FG voltage v > the second preset voltage threshold V2, then the motor performs reverse rotation for door closing.

Further, step S24 specifically comprises the following steps:
S241: if the MCU has not received a motor operation command, then acquiring the FG voltage v of the motor;
S242: determining whether the FG voltage v of the motor > a preset motor stop threshold V4;
S243: if the FG voltage v of the motor ≤ the preset motor stop threshold V4, then the oven lamp is turned off;
S244: if the FG voltage v of the motor > the preset motor stop threshold V4, then acquiring the motor FG voltage v1 after a first preset time t1;
S245: determining whether the motor FG voltage v1 after the first preset time t1 > a fifth preset voltage threshold V5;
S246: if the motor FG voltage v1 after the first preset time t1 > the fifth preset voltage threshold V5, then the MCU sends a forward rotation command, the motor performs forward rotation for door opening, and enters a motor forward rotation door opening determination mode;
S247: if the motor FG voltage v1 after the first preset time t1 ≤ the fifth preset voltage threshold V5, then the MCU sends a reverse rotation command, the motor performs reverse rotation for door closing, and enters a motor reverse rotation door closing determination mode.

Further, the forward rotation of the motor for door opening further comprises the following steps:
acquiring the motor FG voltage v;
determining whether the motor FG voltage v > a preset stall voltage threshold V3;
if the motor FG voltage v > the preset stall voltage threshold V3, then the MCU sends a motor stop command, and the motor stops.

A second aspect of the present disclosure provides a drawer-type microwave oven, wherein the drawer-type microwave oven uses the control method for a drawer-type microwave oven as described above.

Further, the oven body further comprises an outer shell, a first air inlet structure is provided on the outer shell, an air outlet is provided on the front plate of the inner liner, a first heat dissipation air duct and a second heat dissipation air duct are provided between the outer shell and the inner liner, and the lighting assembly is located within the second heat dissipation air duct.

Further, the outer shell comprises a rear plate, a fan assembly and a partition plate are provided between the rear plate and the inner liner, the partition plate cooperates with the fan assembly and divides the rear region of the heating cavity to form a first cavity and a second cavity, the fan assembly is provided at an upper portion of the first cavity for driving external air to sequentially enter the first cavity and the second cavity through the first air inlet structure to form the first heat dissipation air duct.

Further, the air outlet is provided on a side of the bottom of the front plate proximate to the fan assembly, and a second heat dissipation air duct is formed between an outlet airflow of the second cavity and the air outlet.

Further, the drawer-type microwave oven further comprises a microwave heating assembly, the microwave heating assembly is provided at a central position of the top wall, and the lighting assembly is provided at a front side of the top wall.

Further, the light-collecting protective lamp cover is detachably connected to the side folded edge of the top wall.

Further, a second mounting hole is provided on the light-collecting protective lamp cover, a third mounting hole is provided on the side folded edge of the top wall, and the second mounting hole cooperates with the third mounting hole.

Further, a mounting flange is provided on the light-collecting protective lamp cover, and the second mounting hole is provided on the mounting flange.

Further, a clearance hole is provided on the light-collecting protective lamp cover, and the clearance hole is used for providing clearance for the oven lamp.

Further, the oven lamp is detachably connected to the light-collecting protective lamp cover.

Compared with the prior art, the drawer-type microwave oven and control method of the present disclosure have the following beneficial effects:
1) The drawer-type microwave oven and control method of the present disclosure, on one hand, greatly enhances the convenience of use; the oven lamp can be controlled to illuminate according to actual needs, allowing users to clearly view the food condition inside the drawer even when the drawer is partially pulled out or the oven door is not fully opened; on the other hand, improves control flexibility; no longer limited to a single oven door state control method, the on/off state of the oven lamp can be flexibly adjusted according to different usage scenarios and operating conditions, better satisfying diversified user needs and enhancing the user experience of the product.
2) In the drawer-type microwave oven and control method of the present disclosure, the central axis of the oven lamp is arranged parallel to the top wall, a protruding portion is provided on the top wall of the inner liner, a light-transmitting hole is provided on the protruding portion, and a heat dissipation hole structure is provided on the light-collecting protective lamp cover; on one hand, this not only does not occupy the space of the heating cavity, but also increases the usable area of the heating cavity; on the other hand, it increases the structural strength of the heating cavity, preventing deformation of the top wall caused by factors such as heat and pressure generated during the installation or use of the lighting assembly; furthermore, it also improves the heat dissipation effect of the oven lamp, ensures the stability of the oven lamp during prolonged operation, and further enhances the performance of the entire lighting assembly.

### BRIEF DESCRIPTION OF THE DRAWINGS

FIG. 1 is a first schematic perspective view of a drawer-type microwave oven according to an embodiment of the present disclosure;

FIG. 2 is a second schematic perspective view of a drawer-type microwave oven according to an embodiment of the present disclosure;

FIG. 3 is a third schematic perspective view of a drawer-type microwave oven according to an embodiment of the present disclosure;

FIG. 4 is a fourth schematic perspective view of a drawer-type microwave oven according to an embodiment of the present disclosure;

FIG. 5 is a schematic partially exploded perspective view of a drawer-type microwave oven according to an embodiment of the present disclosure;

FIG. 6 is an enlarged schematic perspective view of portion A in FIG. 5;

FIG. 7 is a first schematic perspective view of a light-collecting protective lamp cover of a drawer-type microwave oven according to an embodiment of the present disclosure;

FIG. 8 is a second schematic perspective view of a light-collecting protective lamp cover of a drawer-type microwave oven according to an embodiment of the present disclosure;

FIG. 9 is a fifth schematic perspective view of a drawer-type microwave oven according to an embodiment of the present disclosure;

FIG. 10 is a sixth schematic perspective view of a drawer-type microwave oven according to an embodiment of the present disclosure;

FIG. 11 is a schematic perspective view of a drawer of a drawer-type microwave oven according to an embodiment of the present disclosure;

FIG. 12 is a first flowchart of a control method of a drawer-type microwave oven according to an embodiment of the present disclosure;

FIG. 13 is a second flowchart of a control method of a drawer-type microwave oven according to an embodiment of the present disclosure.

### Description of Reference Numerals:

100. drawer-type microwave oven; 1. oven body; 101. first air inlet structure; 11. outer shell; 111. rear plate; 112. top plate; 113. bottom plate; 114. right side plate; 12. inner liner; 121. top wall; 1211. protruding portion; 1212. light-transmitting hole; 1213. third mounting hole; 124. rear wall; 125. front plate; 1251. air outlet; 16. partition plate; 2. drawer; 21. door body; 211. door glass; 22. carrying portion; 3. heating cavity; 30. first cavity; 31. fan assembly; 4. microwave heating assembly; 40. second cavity; 41. magnetron; 6. storage cavity; 70. lighting assembly; 71. oven lamp; 711. fourth mounting hole; 72. light-collecting protective lamp cover; 721. first mounting hole; 722. second mounting hole; 723. heat dissipation hole structure; 7231. first heat dissipation hole; 7232. second heat dissipation hole; 7233. third heat dissipation hole; 724. clearance hole; 725. mounting protrusion; 726. mounting flange; 73. flat light-transmitting lamp cover.

### DETAILED DESCRIPTION OF EMBODIMENTS

In order to facilitate understanding of the technical means, objectives, and effects of the present disclosure, the embodiments of the present disclosure are described in detail below with reference to specific drawings.

It should be noted that all terms in the present disclosure indicating directions and positions, such as "upper", "lower", "left", "right", "front", "rear", "vertical", "horizontal", "inner", "outer", "top", "bottom", "lateral", "longitudinal", "center", etc., are only used to explain the relative positional relationships and connections between components in a specific state (as shown in the drawings), and are merely for the convenience of describing the present disclosure, rather than requiring the present disclosure to be constructed and operated in a specific orientation. Therefore, these terms should not be construed as limitations on the present disclosure. Additionally, descriptions involving "first", "second", etc. in the present disclosure are only for descriptive purposes and should not be construed as indicating or implying relative importance or implicitly specifying the quantity of the indicated technical features.

In the description of the present disclosure, unless otherwise expressly specified and limited, the terms "mounted", "connected", and "coupled" should be understood in a broad sense. For example, they may refer to fixed connections, detachable connections, or integral connections; they may refer to mechanical connections; they may refer to direct connections or indirect connections through intermediate media, and may refer to internal communication between two elements. For those of ordinary skill in the art, the specific meanings of the above terms in the present disclosure can be understood according to specific circumstances.

In the description of this specification, descriptions with reference to terms such as "one embodiment", "some embodiments", "illustrative embodiments", "examples", "specific examples", or "some examples" mean that specific features, structures, materials, or characteristics described in conjunction with the embodiment or example are included in at least one embodiment or example of the present disclosure. In this specification, schematic representations of the above terms do not necessarily refer to the same embodiment or example. Furthermore, the specific features, structures, materials, or characteristics described may be combined in any suitable manner in any one or more embodiments or examples.

The present disclosure will be described in detail below with reference to the accompanying drawings and in conjunction with embodiments.

### Embodiment 1

In the prior art, the oven lamp 71 of a microwave oven is controlled solely based on the door state: the oven lamp automatically turns on when the oven door is opened, and automatically turns off when the oven door is closed. Although this control logic is simple, low-cost, and conforms to the concept of energy conservation, it is limited to a single door state control method, has poor control flexibility, and cannot adequately meet the diversified usage needs of users.

To solve the above technical problems, the present embodiment proposes a control method for a drawer-type microwave oven. The drawer-type microwave oven 100 includes an oven body 1, a drawer 2, a motor, and a lighting assembly 70. The drawer 2 is connected to the oven body 1. The motor is used to drive the drawer 2 to move in a front-rear direction relative to the oven body 1. The lighting assembly 70 includes an oven lamp 71.

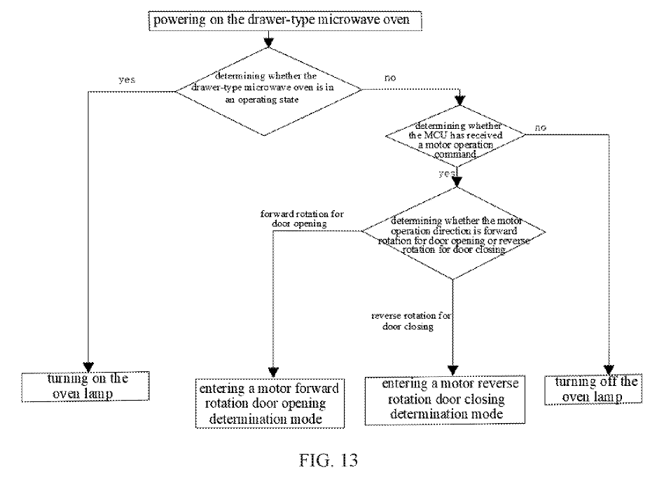

As shown in FIGS. 12 and FIG. 13, the control method includes the following steps:
S1: powering on the drawer-type microwave oven 100;
S2: controlling the oven lamp 71 based on the state of the drawer-type microwave oven 100 and the motor operation.

The control method for the drawer-type microwave oven described in the present embodiment controls the oven lamp 71 based on the state of the drawer-type microwave oven 100 and the motor operation. On one hand, this greatly enhances the convenience of use; the oven lamp 71 can be controlled to turn on according to actual needs, allowing users to clearly view the food condition inside the drawer 2 even without opening the drawer 2. On the other hand, it improves control flexibility; no longer limited to a single door state control method, it can flexibly adjust the on/off state of the oven lamp 71 according to different usage scenarios and operating conditions, better meeting the diversified usage needs of users and enhancing the user experience of the product.

In the prior art, food cannot be observed during closed-door cooking, necessitating interruption of the cooking process, which affects the results.

Specifically, step S2 includes the following steps:
S21: determining whether the drawer-type microwave oven 100 is in an operating state;
S22: if the drawer-type microwave oven 100 is in an operating state, turning on the oven lamp 71;
S23: if the drawer-type microwave oven 100 is not in an operating state, determining whether the MCU has received a motor operation command;
S24: if the MCU has not received a motor operation command, turning off the oven lamp 71.

Steps S21 to S24 are interrelated and work together. Through step S21, it is determined whether the drawer-type microwave oven 100 is in an operating state, facilitating control of the oven lamp 71 based on whether the drawer-type microwave oven 100 is in an operating state. Through step S22, when the drawer-type microwave oven 100 is in an operating state, the oven lamp 71 is turned on, which perfectly solves the problem of traditional microwave ovens being unable to observe food during cooking with the door closed, allowing users to monitor the food status at any time throughout the entire cooking process, thereby improving the controllability and safety of cooking. In step S23, if the drawer-type microwave oven 100 is not in an operating state, it is determined whether the MCU has received a motor operation command. This multi-level determination logic can precisely determine the current state of the drawer-type microwave oven 100, distinguishing between standby state and other non-operating states that may have action requirements, providing an accurate basis for subsequent control of the oven lamp 71. In step S24, when the drawer-type microwave oven 100 is not in an operating state and the MCU has not received a motor operation command, indicating that the drawer-type microwave oven 100 is in a standby state, the oven lamp 71 is turned off. This design avoids the oven lamp 71 being illuminated for extended periods when unnecessary, effectively reducing energy consumption, conforming to the concept of energy conservation and environmental protection, while also reducing equipment operating costs. Furthermore, turning off the oven lamp in standby state does not produce unnecessary light and can reduce interference to users, especially in nighttime or light-sensitive environments, creating a more comfortable and quiet usage environment for users and improving the user experience.

Specifically, step S2 further includes the following steps:
S25: if the MCU has received a motor operation command, determining whether the motor operation direction is forward rotation for door opening or reverse rotation for door closing;
S26: if it is motor forward rotation for door opening, entering the motor forward rotation door opening determination mode;
S27: if it is motor reverse rotation for door closing, entering the motor reverse rotation door closing determination mode.

Steps S25 to S27 are interrelated and work together. By determining whether the motor operation direction is forward rotation for door opening or reverse rotation for door closing, and entering the corresponding determination mode respectively, the oven lamp 71 can be precisely controlled according to different movement states of the drawer 2. This clearly defined mode enables more reasonable allocation and utilization of system resources, improving the operating efficiency and stability of the system.

Specifically, the motor forward rotation door opening determination mode includes the following steps:
the motor rotates forward for door opening;
the oven lamp 71 is turned on.

In the motor forward rotation door opening determination mode, the motor rotates forward for door opening, indicating that the user wants to open the drawer 2. At this time, the oven lamp 71 is turned on. The oven lamp 71 turns on instantly after the user issues the command, providing faster response and delay-free illumination, thereby improving the user experience.

Specifically, the motor forward rotation door opening determination mode further includes the following steps:
acquiring the motor FG voltage v;
determining whether the motor FG voltage v > a preset stall voltage threshold V3;
if the motor FG voltage v > the preset stall voltage threshold V3, the MCU sends a motor stop command, and the motor stops.

In the motor forward rotation door opening determination mode, during the process of motor forward rotation for door opening, indicating that the user wants to open the drawer 2, if the motor FG voltage v > the preset stall voltage threshold V3, a stop command can be issued at the instant when a stall occurs, thereby achieving active safety protection, preventing damage from escalating, and greatly improving the reliability, safety, and user satisfaction of the product.

Specifically, the motor reverse rotation door closing determination mode includes the following steps:
the motor rotates in reverse for door closing;
determining whether the motor has stopped;
if the motor has not stopped, the oven lamp 71 is turned on.

In the motor reverse rotation door closing determination mode, the motor rotates in reverse for door closing; if the motor has not stopped, indicating that the door closing action is in progress, the oven lamp 71 is turned on until the action is completed, thereby achieving full-process illumination during door closing and eliminating visual blind spots and safety hazards. This transforms what might otherwise be a blind spot in safety and user experience into a safe, reliable, and quality-oriented visual operation guidance process, which greatly improves the safety, ease of use, and premium feel of the product.

Specifically, the motor reverse rotation door closing determination mode further includes the following steps:
if the motor has stopped, acquiring the motor FG voltage v;
determining whether the motor FG voltage v > a preset stall voltage threshold V3;
if the motor FG voltage v > the preset stall voltage threshold V3, indicating that the motor has stopped due to a stall, the oven lamp 71 is turned on;
if the motor FG voltage v ≤ the preset stall voltage threshold V3, indicating that the motor has not stopped due to a stall, the oven lamp 71 is turned off.

In the motor reverse rotation door closing determination mode, if the motor has stopped, acquiring the motor FG voltage v facilitates determining whether the motor has stopped due to a stall. If the motor has stopped due to a stall caused by anti-pinch protection or other obstacles, the oven lamp 71 is turned on as an abnormal warning, visually attracting the user's attention and informing the user that the system is not in normal standby mode but has entered a protection state requiring inspection. If the motor has not stopped due to a stall, indicating that the drawer 2 has been normally closed without abnormality, the system enters standby mode, and the oven lamp 71 is turned off to conserve energy.

Specifically, the motor forward rotation door opening determination mode further includes the following steps:
acquiring the motor FG voltage v;
determining whether the motor FG voltage v > a preset stall voltage threshold V3;
if the motor FG voltage v > the preset stall voltage threshold V3, the MCU sends a motor stop command, and the motor stops.

In the motor forward rotation door opening determination mode, during the process of motor forward rotation for door opening, indicating that the user wants to open the drawer 2, if the motor FG voltage v > the preset stall voltage threshold V3, a stop command can be issued at the instant when a stall occurs, thereby achieving active safety protection, preventing damage from escalating, and greatly improving the reliability, safety, and user satisfaction of the product.

Specifically, step S25 includes the following steps:
S251: if the MCU receives a motor operation command, acquiring a motor FG voltage v;
S252: determining whether the motor FG voltage v > a first preset voltage threshold V1;
S253: if the motor FG voltage v > the first preset voltage threshold V1, the motor performs forward rotation for door opening;
S254: if the motor FG voltage v ≤ the first preset voltage threshold V1, determining whether the motor FG voltage v > a second preset voltage threshold V2;
S255: if the motor FG voltage v > the second preset voltage threshold V2, the motor performs reverse rotation for door closing.

In step S25, steps S251 to S255 are interrelated and work together. Acquiring the motor FG voltage v through step S251 facilitates subsequent determination of whether the motor performs forward rotation for door opening or reverse rotation for door closing. Step S252 facilitates determination of whether the motor is performing forward rotation for door opening. Through step S253, when the motor FG voltage v > the first preset voltage threshold V1, it indicates that the motor is performing forward rotation for door opening. Then, step S254 facilitates determination of whether the motor is performing reverse rotation for door closing. In step S255, if the motor FG voltage v > the second preset voltage threshold V2, it indicates that the motor is performing reverse rotation for door closing.

It should be noted that the FG voltage refers to the voltage of a Frequency Generator.

The second preset voltage threshold V2 is less than the first preset voltage threshold V1.

Specifically, step S24 includes the following steps:
S241: if the MCU has not received a motor operation command, acquiring the FG voltage v of the motor;
S242: determining whether the FG voltage v of the motor > a preset motor stop threshold V4;
S243: if the FG voltage v of the motor ≤ the preset motor stop threshold V4, the oven lamp 71 is turned off;
S244: if the FG voltage v of the motor > the preset motor stop threshold V4, acquiring the motor FG voltage v1 after a first preset time t1;
S245: determining whether the motor FG voltage v1 after the first preset time t1 > a fifth preset voltage threshold V5;
S246: if the motor FG voltage v1 after the first preset time t1 > the fifth preset voltage threshold V5, the MCU sends a forward rotation command, the motor rotates forward for door opening, and enters the motor forward rotation door opening determination mode;
S247: if the motor FG voltage v1 after the first preset time t1 ≤ the fifth preset voltage threshold V5, the MCU sends a reverse rotation command, the motor rotates in reverse for door closing, and enters the motor reverse rotation door closing determination mode.

Steps S241 to S247 are interrelated and work together to resynchronize the electrical system state with the user's direct manual operation, preventing state confusion, enabling perception of the actual state in the physical world, achieving intelligent assistance for manual operation, enabling the product to understand the user's physical actions, better satisfying diverse user needs, and enhancing the user experience of the product.

Through steps S241 and S242, it is facilitated to determine whether the user has manually opened or closed the door. In step S243, if the FG voltage v of the motor ≤ the preset motor stop threshold V4, this indicates that the user has not manually opened or closed the door, and the oven lamp 71 is turned off to save energy. In step S244, if the MCU has not received a motor operation command and the FG voltage v of the motor > the preset motor stop threshold V4, this indicates that the user has manually opened or closed the door. In step S245, the motor FG voltage v1 is detected again after the first preset time t1 for determination, preventing false actions caused by accidental vibrations or slight touches. If voltage can still be detected after time t1, it indicates an intentional operation rather than an accidental touch, greatly improving the anti-interference capability and determination accuracy of the system. Through step S246, it is facilitated to determine whether the user has manually opened or manually closed the door.

Further, in the present embodiment, the first preset voltage threshold V1, the second preset voltage threshold V2, the preset stall voltage threshold V3, the preset motor stop threshold V4, the fifth preset voltage threshold V5, and the first preset time t1 are all preset values and are not specifically limited herein.

### Embodiment 2

In the prior art, the central axis of the oven lamp 71 is arranged perpendicular to the top wall 121 of the cooking chamber, and the cooking chamber is recessed inward at the installation location of the oven lamp 71. On one hand, this occupies space in the cooking chamber, reducing the usable area of the cooking chamber; on the other hand, it reduces the structural strength of the cooking chamber; furthermore, the heat dissipation effect of the oven lamp 71 is poor.

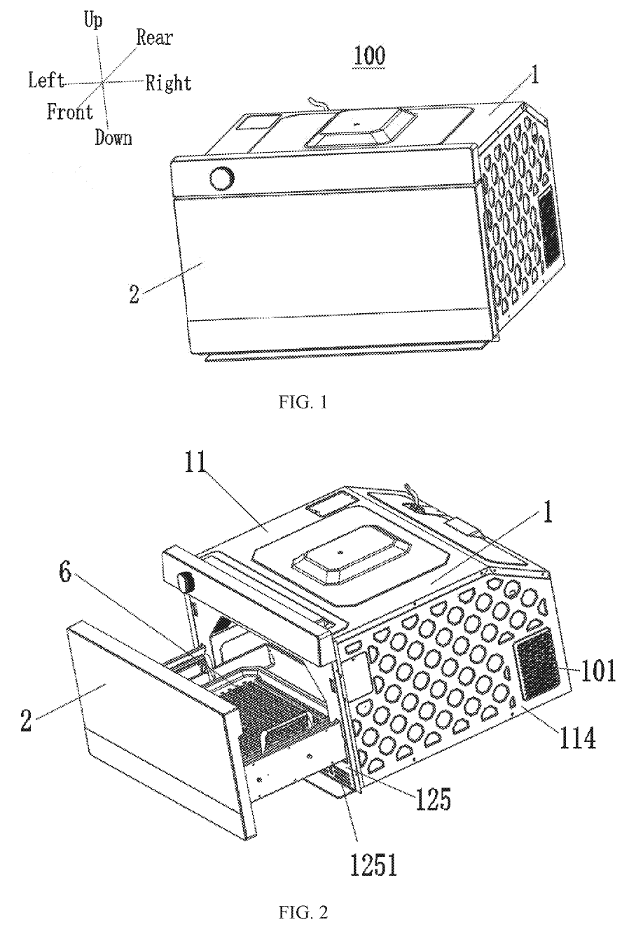

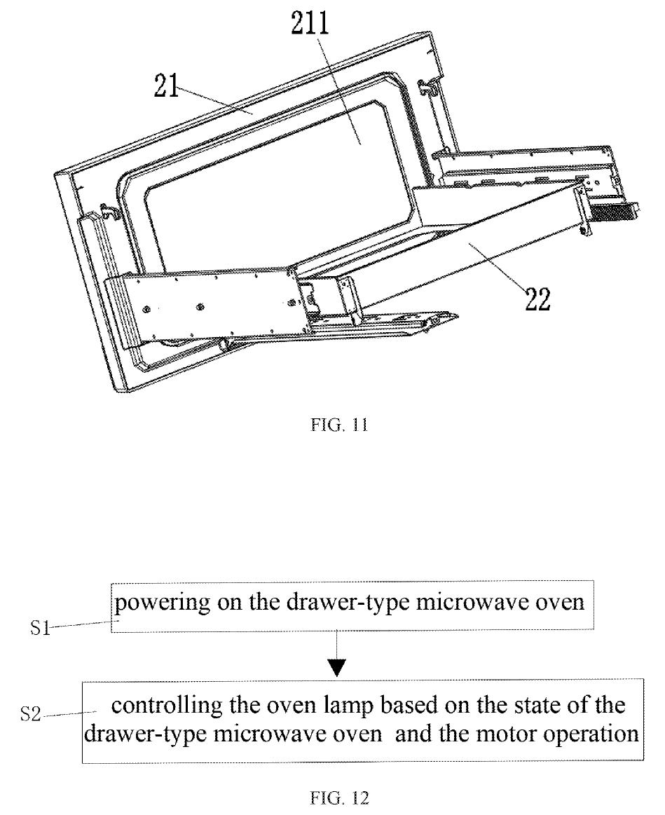

To solve the above technical problems, as shown in FIGS. 1 to 11, the present embodiment proposes a drawer-type microwave oven 100, wherein the drawer-type microwave oven uses the control method for a drawer-type microwave oven as described in Embodiment 1.

The drawer-type microwave oven 100 comprises an oven body 1 and a lighting assembly 70. The oven body 1 comprises an inner liner 12, and a heating cavity 3 is formed within the inner liner 12. A protruding portion 1211 is provided on the top wall 121 of the inner liner 12, and a light-transmitting hole 1212 is provided on the protruding portion 1211. The lighting assembly 70 is disposed above and outside the protruding portion 1211, and the lighting assembly 70 comprises:
an oven lamp 71, wherein the oven lamp 71 is installed above the exterior of the inner liner 12, the oven lamp 71 corresponds in position to the light-transmitting hole 1212, and a central axis of the oven lamp 71 is arranged parallel to the top wall 121;
a flat light-transmitting lamp cover 73, wherein the flat light-transmitting lamp cover 73 can protect the oven lamp 71 from oil stains, water vapor, food residue, and the like generated during the cooking process, thereby extending the service life of the oven lamp 71; the flat light-transmitting lamp cover 73 is disposed between the oven lamp 71 and the top wall 121;
a light-collecting protective lamp cover 72, wherein the light-collecting protective lamp cover 72 is disposed over the exterior of the oven lamp 71, the oven lamp 71 is mounted on the light-collecting protective lamp cover 72, and a heat dissipation hole structure 723 is provided on the light-collecting protective lamp cover 72.

In the drawer-type microwave oven 100 proposed in this embodiment, the light-transmitting hole 1212 serves as a channel through which light propagates from the oven lamp 71 into the heating cavity 3, enabling the light emitted by the oven lamp 71 to illuminate the heating cavity 3 and provide lighting for the user to observe the cooking state of food. The protruding portion 1211 provides space for the arrangement of the light-transmitting hole 1212, while potentially enhancing the strength of the top wall 121 in this region. By providing the protruding portion 1211 and the light-transmitting hole 1212, a suitable mounting position and light channel are provided for the lighting assembly 70, enabling light to accurately illuminate the interior of the heating cavity 3; the oven lamp 71 serves as the light source of the lighting assembly 70, responsible for emitting light and providing illumination for the cooking chamber through the light-transmitting hole 1212 and the flat light-transmitting lamp cover 73; the flat light-transmitting lamp cover 73 allows light emitted by the oven lamp 71 to pass through while providing a certain degree of scattering and uniformization of the light, making the light illuminating the cooking chamber softer and more uniform, avoiding localized areas that are overly bright or overly dark, and improving observation effectiveness; the flat light-transmitting lamp cover 73 can also protect the oven lamp 71 from oil stains, water vapor, food residue, and the like generated during the cooking process, thereby extending the service life of the oven lamp 71. The light-collecting protective lamp cover 72 not only collects and directs the light emitted by the oven lamp 71 to a certain extent, causing the light to pass through the light-transmitting hole 1212 in a more concentrated manner to illuminate the cooking chamber and improve lighting efficiency; the light-collecting protective lamp cover 72 also provides protection for the oven lamp 71, preventing external objects from impacting or damaging the oven lamp 71. The provision of the heat dissipation hole structure 723 helps dissipate heat generated by the oven lamp 71 during operation, reducing the temperature of the oven lamp 71, ensuring its normal operation, and extending its service life.

In the drawer-type microwave oven 100 proposed in this embodiment, the central axis of the oven lamp 71 is arranged parallel to the top wall 121, the protruding portion 1211 is provided on the top wall 121 of the inner liner 12, the light-transmitting hole 1212 is provided on the protruding portion 1211, and the heat dissipation hole structure 723 is provided on the light-collecting protective lamp cover 72; on one hand, this not only does not occupy space in the heating cavity 3, but also increases the usable area of the heating cavity 3; on the other hand, it increases the structural strength of the heating cavity 3, preventing deformation of the top wall 121 due to factors such as heat and pressure generated during installation or use of the lighting assembly 70; furthermore, it improves the heat dissipation effect of the oven lamp 71, ensures the stability of the oven lamp 71 during prolonged operation, and further enhances the performance of the entire lighting assembly 70.

As shown in FIG. 2, the oven body 1 further comprises an outer shell 11, a first air inlet structure 101 is provided on the outer shell 11, an air outlet 1251 is provided on the front plate 125 of the inner liner 12, a first heat dissipation air duct and a second heat dissipation air duct are provided between the outer shell 11 and the inner liner 12, and the lighting assembly 70 is located within the second heat dissipation air duct.

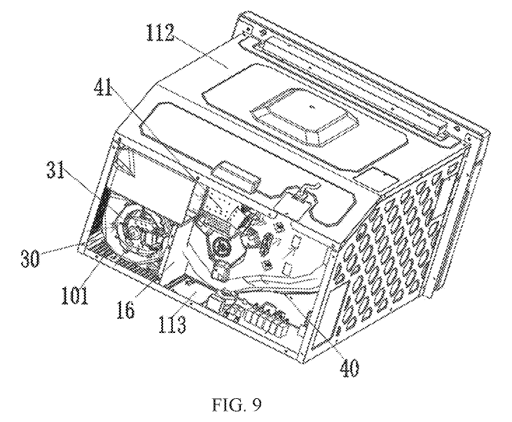

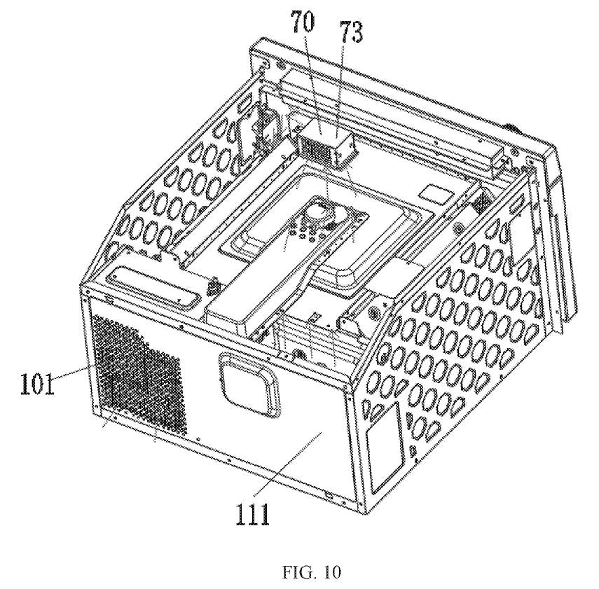

As a preferred example of the present application, as shown in FIGS. 9 and FIG. 10, the outer shell 11 comprises a rear plate 111, a fan assembly 31 and a partition plate 16 are disposed between the rear plate 111 and the inner liner 12, one side of the partition plate 16 is connected to the rear wall 124 of the inner liner 12, and the other side of the partition plate 16 is connected to the rear plate 111; the partition plate 16 cooperates with the fan assembly 31 and divides the rear region of the heating cavity 3 to form a first chamber 30 and a second chamber 40, the fan assembly 31 is disposed at an upper portion of the first chamber 30, and the fan assembly 31 is configured to drive external air to sequentially enter the first chamber 30 and the second chamber 40 through the first air inlet structure 101 to form the first heat dissipation air duct.

This arrangement forces airflow from the first chamber 30 into the second chamber 40 through the partition plate 16, eliminating turbulent interference of conventional open air ducts and improving the heat dissipation efficiency of the first heat dissipation air duct; meanwhile, the isolated design of the first chamber 30 can ensure that the operating environment temperature of the motor of the fan assembly 31 is ≤45°C, significantly extending its service life; furthermore, the partition plate 16 can effectively prevent vibration transmission from the fan assembly 31, preventing abnormal noise caused by resonance.

As a preferred example of the present application, as shown in FIG. 9, the drawer-type microwave oven 100 further comprises a magnetron 41, and the magnetron 41 is disposed at an outlet of the fan assembly 31. This arrangement facilitates heat dissipation of the magnetron 41 by the fan assembly 31.

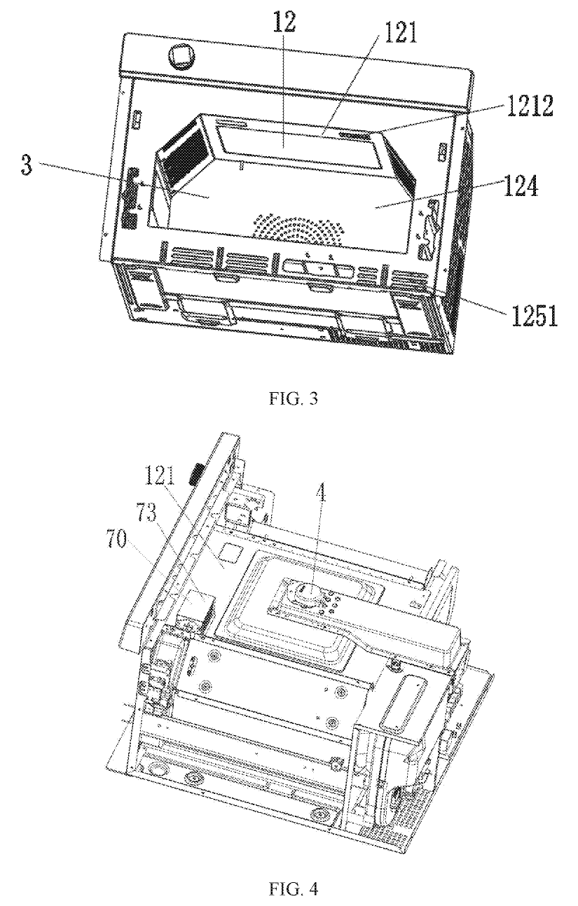

As a preferred example of the present application, as shown in FIGS. 2 and FIG.3, the air outlet 1251 is disposed on a side of the bottom of the front plate 125 proximate to the fan assembly 31, and as shown in FIG. 10, a second heat dissipation air duct is formed between the outlet airflow of the second chamber 40 and the air outlet 1251.

This arrangement enables air from the first heat dissipation air duct to flow out from the top of the second chamber 40 and pass over the top of the heating cavity 3, and then be discharged from the air outlet 1251 of the front plate 125, thereby achieving heat dissipation for the lighting assembly 70.

As a preferred example of the present application, as shown in FIGS. 9 and FIG. 10, the outer shell 11 further comprises a bottom plate 113, and the first air inlet structure 101 comprises ventilation holes provided in at least one of the rear plate 111 and/or the bottom plate 113. This arrangement provides the drawer-type microwave oven 100 with a large air inlet area and low air inlet resistance, thereby further improving heat dissipation efficiency. Preferably, support feet are provided below the bottom plate 113. This arrangement ensures that a gap exists between the bottom plate 113 and the bottom wall of the built-in space, thereby facilitating the entry of external air.

Preferably, as shown in FIG. 2, the outer shell 11 further comprises a left side plate and a right side plate 114, and the first air inlet structure 101 further comprises ventilation holes provided in the left side plate or the right side plate 114. This arrangement enables air intake simultaneously from the bottom, rear, and sides of the drawer-type microwave oven 100, avoiding situations where individual ventilation holes are blocked resulting in ineffective heat dissipation, thereby providing more stable heat dissipation.

As shown in FIG. 9, the outer shell 11 further comprises a top plate 112.

As a preferred example of the present application, the projected area of the flat light-transmitting lamp cover 73 on the top wall 121 is larger than that of the protruding portion 1211. This design ensures that the flat light-transmitting lamp cover 73 can completely cover the protruding portion 1211 and the light-transmitting hole 1212 thereon, providing better protection and light transmission effects. Meanwhile, the larger projected area may also help enhance the installation stability of the flat light-transmitting lamp cover 73, enabling it to be more securely fixed on the top wall 121.

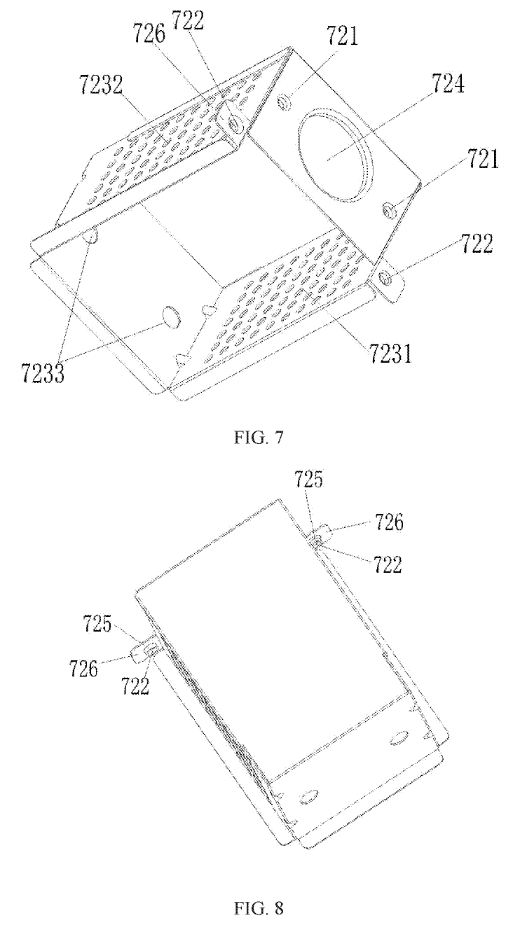

As a preferred example of the present application, as shown in FIG. 7, a clearance hole 724 is provided on the light-collecting protective lamp cover 72, and the clearance hole 724 is configured to provide clearance for the oven lamp 71. This arrangement facilitates the installation of the oven lamp 71.

As a preferred example of the present application, as shown in FIG. 7, the heat dissipation hole structure 723 comprises a first heat dissipation hole 7231 and a second heat dissipation hole 7232, and the first heat dissipation hole 7231 and the second heat dissipation hole 7232 are symmetrically disposed on front and rear sides of the light-collecting protective lamp cover 72. This arrangement improves the heat dissipation uniformity and heat dissipation efficiency of the oven lamp 71.

As a preferred example of the present application, as shown in FIG. 7, the heat dissipation hole structure 723 further comprises a third heat dissipation hole 7233. This arrangement further improves the heat dissipation effect of the oven lamp 71.

As a preferred example of the present application, the oven lamp 71 is detachably connected to the light-collecting protective lamp cover 72.

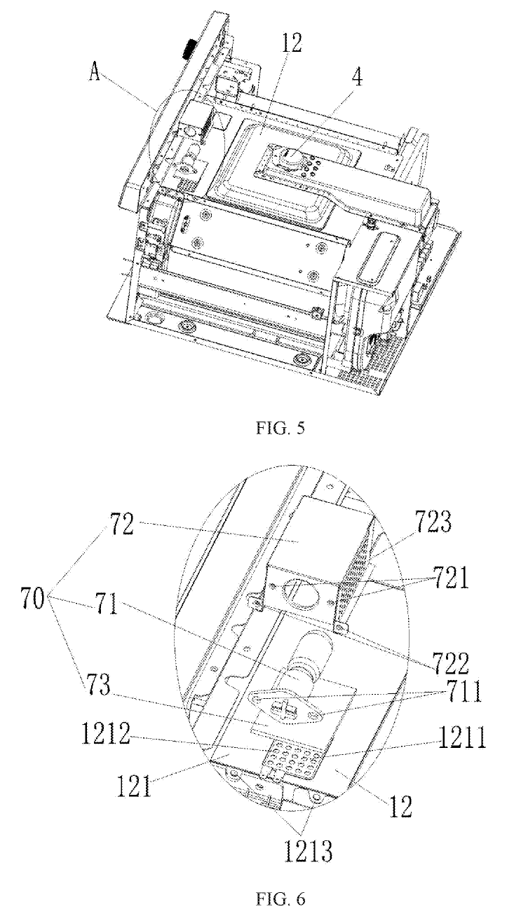

As a preferred example of the present application, as shown in FIG. 7, a first mounting hole 721 is provided on the light-collecting protective lamp cover 72, and as shown in FIG. 6, a fourth mounting hole 711 is provided on the oven lamp 71, wherein the first mounting hole 721 cooperates with the fourth mounting hole 711.

As a preferred example of the present application, as shown in FIG. 7, two first mounting holes 721 are provided, and the two first mounting holes 721 are symmetrically disposed on both sides of the clearance hole 724. This arrangement improves the installation balance and installation strength of the oven lamp 71.

As a preferred example of the present application, as shown in FIGS. 4 and FIG. 5, the drawer-type microwave oven 100 further comprises a microwave heating assembly 4, the microwave heating assembly 4 is configured to deliver microwaves to the heating cavity 3, and the microwave heating assembly 4 is disposed at a central position of the top wall 121. This design has multiple advantages: first, it enables microwaves to cover the food in the heating cavity 3 relatively uniformly, improving the heating uniformity of the food; second, the structural layout is reasonable, and disposing the microwave heating assembly 4 on the top wall 121 does not occupy the space of the side walls or rear wall 124 of the inner liner 12, making the internal space of the heating cavity 3 more regular, which is conducive to food placement and the cooking process; third, the position of the top wall 121 is relatively open, facilitating the installation and removal of the microwave heating assembly 4.

As a preferred example of the present application, as shown in FIGS. 4 and FIG. 10, the lighting assembly 70 is disposed on the front side of the top wall 121. Considering that users typically stand in front of the drawer-type microwave oven 100 during operation, disposing the lighting assembly 70 on the front side of the top wall 121 can prevent light from being blocked by the user's body or other objects, ensuring that users can obtain good lighting effects from different angles, allowing users to more clearly observe the color, doneness, and other conditions of the food, and facilitating timely adjustment of cooking parameters.

As a preferred example of the present application, the light-collecting protective lamp cover 72 is detachably connected to the side folded edge of the top wall 121.

As a preferred example of the present application, as shown in FIGS. 6 to 8, a second mounting hole 722 is provided on the light-collecting protective lamp cover 72, and as shown in FIG. 6, a third mounting hole 1213 is provided on the side folded edge of the top wall 121, wherein the second mounting hole 722 cooperates with the third mounting hole 1213.

As a preferred example of the present application, as shown in FIGS. 7 and FIG. 8, a mounting flange 726 is provided on the light-collecting protective lamp cover 72, and the second mounting hole 722 is provided on the mounting flange 726. This arrangement enhances the connection strength between the light-collecting protective lamp cover 72 and the side folded edge of the top wall 121.

As a preferred example of the present application, as shown in FIG. 8, a mounting protrusion 725 is provided on the mounting flange 726, and the second mounting hole 722 is provided on the mounting protrusion 725. This arrangement further enhances the connection strength between the light-collecting protective lamp cover 72 and the side folded edge of the top wall 121.

As a preferred example of the present application, as shown in FIGS. 1 and FIG. 2, the drawer-type microwave oven 100 further includes a drawer 2, wherein a storage cavity 6 is provided on the drawer 2 for storing food to be heated; the drawer 2 is slidably disposed on the oven body 1, facilitating users to place and remove food.

Specifically, the drawer 2 includes a door body 21 and a carrying portion 22, wherein the storage cavity 6 is formed in the carrying portion 22, and a door glass 211 is installed on the door body 21.

Regarding other related components of the drawer-type microwave oven 100, since the specific structures of these related components and their specific assembly relationships are all prior art, they will not be described in detail herein.

The drawer-type microwave oven 100 proposed in the present embodiment has the central axis of the oven lamp 71 arranged parallel to the top wall 121, a protruding portion 1211 provided on the top wall 121 of the inner liner 12, a light-transmitting hole 1212 provided on the protruding portion 1211, and a heat dissipation hole structure 723 provided on the light-collecting protective lamp cover 72. On one hand, this configuration not only does not occupy the space of the heating cavity 3, but also increases the usable area of the heating cavity 3; on the other hand, it increases the structural strength of the heating cavity 3, preventing deformation of the top wall 121 caused by factors such as heat and pressure generated during the installation or use of the lighting assembly 70; furthermore, it also improves the heat dissipation effect of the oven lamp 71, ensures the stability of the oven lamp 71 during long-term operation, and further enhances the performance of the entire lighting assembly 70.

Although the present disclosure is disclosed as above, the present disclosure is not limited thereto. Any person skilled in the art may make various changes and modifications without departing from the spirit and scope of the present disclosure, and therefore the protection scope of the present disclosure shall be determined by the scope defined by the claims.

1. A control method for a drawer-type microwave oven, wherein the drawer-type microwave oven comprises an oven body, a drawer, a motor, and a lighting assembly, the drawer is connected to the oven body, the motor is configured to drive the drawer to move in a front-rear direction relative to the oven body, the oven body comprises an inner liner having a top wall, a heating cavity is formed within the inner liner, a protruding portion is provided on the top wall of the inner liner, a light-transmitting hole is provided on the protruding portion, the lighting assembly is disposed above and outside the protruding portion, the lighting assembly comprises:
an oven lamp, wherein the oven lamp is positioned corresponding to the light-transmitting hole, and a central axis of the oven lamp is arranged parallel to the top wall;
a flat light-transmitting lamp cover, wherein the flat light-transmitting lamp cover is disposed between the oven lamp and the top wall; and
a light-collecting protective lamp cover, wherein the light-collecting protective lamp cover is disposed to cover the exterior of the oven lamp, the oven lamp is mounted on the light-collecting protective lamp cover, and a heat dissipation hole structure is provided on the light-collecting protective lamp cover;
the control method comprising the following steps:
powering on the drawer-type microwave oven; and
controlling the oven lamp based on the state of the drawer-type microwave oven and the motor operation.

2. The control method for a drawer-type microwave oven according to claim 1, wherein controlling the oven lamp comprises the following steps:
S21: determining whether the drawer-type microwave oven is in an operating state;
S22: if the drawer-type microwave oven is in the operating state, turning on the oven lamp;
S23: if the drawer-type microwave oven is not in the operating state, determining whether a MCU has received a motor operation command; and
S24: if the MCU has not received a motor operation command, turning off the oven lamp.

3. The control method for a drawer-type microwave oven according to claim 2, wherein controlling the oven lamp further comprises the following steps:
S25: if the MCU has received a motor operation command, determining whether the motor operation direction is forward rotation for door opening or reverse rotation for door closing;
S26: if it is motor forward rotation for door opening, entering a motor forward rotation door opening determination mode; and
S27: if it is motor reverse rotation for door closing, entering a motor reverse rotation door closing determination mode.

4. The control method for a drawer-type microwave oven according to claim 3, wherein the motor forward rotation door opening determination mode comprises the following steps:
the motor rotates forward to open the door; and
the oven lamp is turned on.

5. The control method for a drawer-type microwave oven according to claim 3, wherein the motor reverse rotation door closing determination mode comprises the following steps:
the motor rotates in reverse to close the door;
determining whether the motor has stopped; and
if the motor has not stopped, the oven lamp is turned on.

6. The control method for a drawer-type microwave oven according to claim 5, wherein the motor reverse rotation door closing determination mode further comprises the following steps:
if the motor has stopped, acquiring a motor FG voltage v;
determining whether the motor FG voltage v > a preset stall voltage threshold V3;
if the motor FG voltage v > the preset stall voltage threshold V3, the motor has stopped due to stall, and the oven lamp is turned on; and
if the motor FG voltage v ≤ the preset stall voltage threshold V3, the motor has not stopped due to stall, and the oven lamp is turned off.

7. The control method for a drawer-type microwave oven according to claim 3, wherein step S25 comprises the following steps:
S251: if the MCU receives a motor operation command, acquiring a motor FG voltage v;
S252: determining whether the motor FG voltage v > a first preset voltage threshold V1;
S253: if the motor FG voltage v > the first preset voltage threshold V1, the motor rotates forward for door opening;
S254: if the motor FG voltage v ≤ the first preset voltage threshold V1, determining whether the motor FG voltage v > a second preset voltage threshold V2; and
S255: if the motor FG voltage v > the second preset voltage threshold V2, the motor rotates in reverse for door closing.

8. The control method for a drawer-type microwave oven according to claim 3, wherein step S24 comprises the following steps:
S241: if the MCU has not received a motor operation command, acquiring a FG voltage v of the motor;
S242: determining whether the FG voltage v of the motor > a preset motor stop threshold V4;
S243: if the FG voltage v of the motor ≤ the preset motor stop threshold V4, the oven lamp is turned off;
S244: if the FG voltage v of the motor > the preset motor stop threshold V4, acquiring a motor FG voltage v1 after a first preset time t1;
S245: determining whether the motor FG voltage v1 after the first preset time t1 > a fifth preset voltage threshold V5;
S246: if the motor FG voltage v1 after the first preset time t1 > the fifth preset voltage threshold V5, the MCU sends a forward rotation command, the motor performs forward rotation for door opening, and enters a motor forward rotation door opening determination mode; and
S247: if the motor FG voltage v1 after the first preset time t1 ≤ the fifth preset voltage threshold V5, the MCU sends a reverse rotation command, the motor performs reverse rotation for door closing, and enters a motor reverse rotation door closing determination mode.

9. The control method for a drawer-type microwave oven according to claim 3, wherein the motor forward rotation for door opening further comprises the following steps:
acquiring a motor FG voltage v;
determining whether the motor FG voltage v > a preset stall voltage threshold V3;
if the motor FG voltage v > the preset stall voltage threshold V3, the MCU sends a motor stop command, and the motor stops.

10. A drawer-type microwave oven, wherein the drawer-type microwave oven uses the control method for a drawer-type microwave oven according to claim 1.

11. The drawer-type microwave oven according to claim 10, wherein the oven body further comprises an outer shell, a first air inlet structure is provided on the outer shell, an air outlet is provided on a front plate of the inner liner, a first heat dissipation air duct and a second heat dissipation air duct are provided between the outer shell and the inner liner, and the lighting assembly is located within the second heat dissipation air duct.

12. The drawer-type microwave oven according to claim 11, wherein the outer shell comprises a rear plate, a fan assembly and a partition plate are provided between the rear plate and the inner liner, the partition plate cooperates with the fan assembly and divides a rear region of the heating cavity to form a first cavity and a second cavity, the fan assembly is provided at an upper portion of the first cavity for driving outside air to sequentially enter the first cavity and the second cavity through the first air inlet structure to form the first heat dissipation air duct.

13. The drawer-type microwave oven according to claim 12, wherein the air outlet is provided on a side of a bottom portion of the front plate proximate to the fan assembly, and a second heat dissipation air duct is formed between an outlet airflow of the second cavity and the air outlet.

14. The drawer-type microwave oven according to claim 10, wherein the drawer-type microwave oven further comprises a microwave heating assembly, wherein the microwave heating assembly is disposed at a central position of the top wall, and the lighting assembly is disposed at a front side of the top wall.

15. The drawer-type microwave oven according to claim 10, wherein the light-collecting protective lamp cover is detachably connected to a side folded edge of the top wall.

16. The drawer-type microwave oven according to claim 15, wherein a second mounting hole is provided on the light-collecting protective lamp cover, a third mounting hole is provided on the side folded edge of the top wall, and the second mounting hole cooperates with the third mounting hole.

17. The drawer-type microwave oven according to claim 16, wherein a mounting flange is provided on the light-collecting protective lamp cover, and the second mounting hole is provided on the mounting flange.

18. The drawer-type microwave oven according to claim 10, wherein a clearance hole is provided on the light-collecting protective lamp cover, wherein the clearance hole is configured to provide clearance for the oven lamp.

19. The drawer-type microwave oven according to claim 10, wherein the oven lamp is detachably connected to the light-collecting protective lamp cover.
